(19) United States
(12) Patent Application Publication
(10) Pub. No.: US 2010/0220476 A1
(43) Pub. Date: Sep. 2, 2010

(54) LED LIGHT TUBE

(75) Inventors: CHENG-HSIUNG KUO, HSIN-TIEN CITY (TW); HSUAN-HUI CHEN, HSIN-TIEN CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: LEDTECH ELECTRONICS, Hsin-Tien City (TW)

(21) Appl. No.: 12/688,134

(22) Filed: Jan. 15, 2010

(30) Foreign Application Priority Data
Feb. 27, 2009 (TW) 098203010

(51) Int. Cl. F21V 1/00; F21S 4/00

(52) U.S. Cl. 362/235; 362/249.02; 362/218

(57) ABSTRACT

A LED light tube is revealed. The LED light tube includes a tube-shaped heat dissipation base, a printed circuit board and a light cover. The light cover includes an outer light emitting layer, an inner light emitting layer and a hollow part formed by a gap between the inner light emitting layer and the outer light emitting layer. The inner light emitting layer of the light cover presses on the printed circuit board in order to fix the printed circuit board on the tube-shaped heat dissipation base so that there is no need to use any other components for fixing the printed circuit board on the tube-shaped heat dissipation base.

### BACKGROUND OF THE INVENTION

1. Fields of the invention

The present invention relates to a light tube, especially to a light emitting diode (LED) light tube.

2. Descriptions of Related Art

Along with the increasing of the living standard, lamps and decorative lighting have received more attention. Once the proper decorative lighting is applied to exterior or interior decoration, it provides not only practical utility but also environment beautification. Now the most common light source for decorative lighting is fluorescent lamp.

A fluorescent lamp is a gas-discharge lamp that uses electricity to excite mercury vapor. The lamp is filled with a gas containing mercury vapor formed by a few drops of mercury and argon. The pressure inside the lamp is around 0.3% of atmospheric pressure and mercury atoms are about one thousandth of the whole gas atoms. By applying current, the gas is excited to produce light. After long term use, dark marks are formed at the lamp ends. This is due to that electrodes are arranged at two ends of the fluorescent lamp and the electrodes are sputtered by collision of argon to form dark marks on lamp wall of two sides of the fluorescent lamp. When both ends of the fluorescent lamp become dark, the lamp is near the end of the life. The light emitted is reduced due to the deposition. Although the fluorescent lamp has an advantage of large light emitting area, it still has a number of shortcomings such as high power consumption and a short life.

In recent years, along with on-going development and broader applications of LED technology, LED related products have become daily essentials. LED emits light by a low-voltage high current way. Moreover, the LED features on long life, low power consumption and lack of heat radiation. Due to above advantages, LED lighting has been developed for environmental friendliness.

However, LED has an overheating problem. Once LED overheats, it dims with reduced light emitting efficiency. Thus LED lights also get the similar problem. In order to solve the overheating problem of the LED light, a plurality of heat dissipation fins is disposed on a heat dissipation member of the present invention. Thus heat dissipation is enhanced, overheating is prevented, and lighting efficiency of the LED light is improved.

A further problem of the LED light is related to assembling. Generally, a printed circuit board is attached or fastened on the heat dissipation member while assembling the LED light. This cause more complicated assembling process and increased cost of assembling. In order to simplify the assembling process and reduce the cost of assembling, the present invention fixes the printed circuit board by a light cover. Thus there is no need to use any other components for fixing the printed circuit board on the heat dissipation member. Therefore, the assembling process is simplified and the cost of assembling is reduced.

### SUMMARY OF THE INVENTION

Therefore it is a primary object of the present invention to provide a LED light tube in which a tube-shaped heat dissipation base is disposed with a plurality of heat dissipation fins so as to enhance heat dissipation effect thereof. Thus the LED overheating can be avoided and the lighting emitting efficiency of the LED light is further improved.

It is another object of the present invention to provide a LED light tube in which a printed circuit board is fixed directly by a light cover and there is no need to use any other components for fixing the printed circuit board on the tube-shaped heat dissipation base. Thus the assembling process is simplified and the cost of assembling is reduced.

In order to achieve above objects, a LED light tube of the present invention includes a tube-shaped heat dissipation base, a printed circuit board and a light cover. The tube-shaped heat dissipation base is disposed with a first fix member on each of two sides thereof and a plurality of heat dissipation fins. The printed circuit board is arranged at the tube-shaped heat dissipation base and the light cover is disposed on the tube-shaped heat dissipation base correspondingly. A second fix member is disposed on each of two sides of the light cover. The second fix member is fixed with the first fix member. The light cover further includes an outer light emitting layer, an inner light emitting layer and a hollow part formed by a gap between the inner light emitting layer and the outer light emitting layer. The inner light emitting layer of the light cover presses on the printed circuit board in order to fix the printed circuit board on the tube-shaped heat dissipation base.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is an explosive view of an embodiment according to the present invention;

FIG. 3 is an explosive view of another embodiment according to the present invention;

FIG. 4 is an explosive view of a further embodiment according to the present invention;

FIG. 5 is an explosive view of a further embodiment according to the present invention;

FIG. 6 is an explosive view of a further embodiment according to the present invention;

FIG. 7 is a perspective view of another embodiment according to the present invention; and

FIG. 8 is a schematic drawing showing cross section of an embodiment according to the present invention.

### DETAILED DESCRIPTION OF THE PREFERRED EMBODIMENT

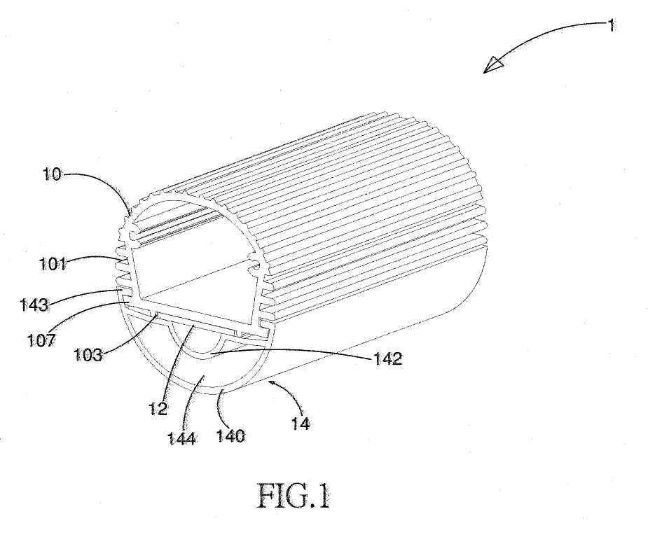

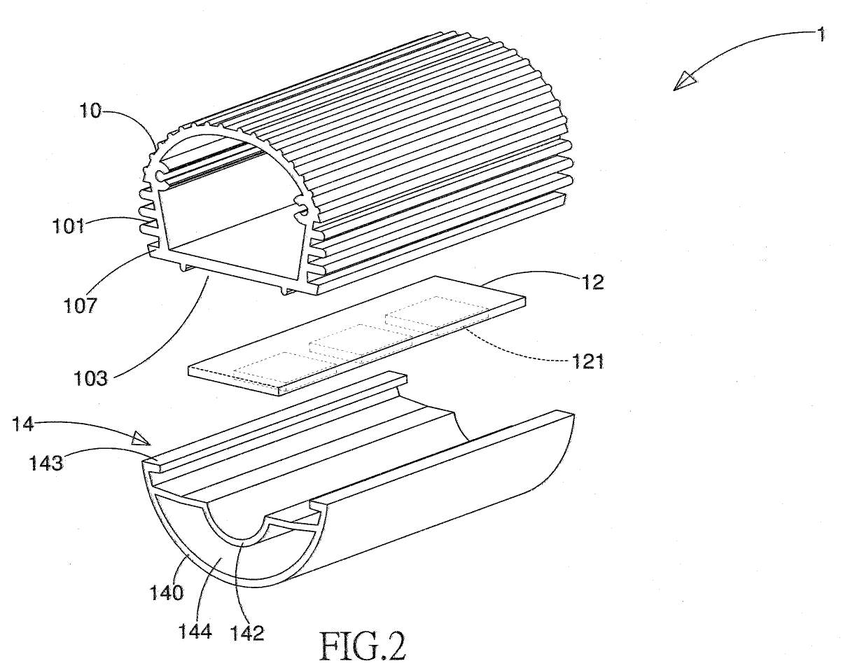

Refer to FIG. 1 and FIG. 2, a perspective view and an explosive view of an embodiment according to the present invention are revealed. As shown in figures, a LED light tube 1 provided by the present invention includes a tube-shaped heat dissipation base 10, a printed circuit board 12 and a light cover 14. The tube-shaped heat dissipation base 10 is a hollow tube made from metal for transferring heat. A plurality of heat dissipation fins 101 and a concave part 103 respectively for heat dissipation and for disposition of the printed circuit board 12 are arranged on a surface of the tube-shaped heat dissipation base 10. A first fix member 107 for fixing is disposed on each of two sides of the tube-shaped heat dissipation base 10. The printed circuit board 12 with a plurality of light emitting diodes 121 is arranged at the concave part 13 on the tube-shaped heat dissipation base 10. The light cover 14 consists of an outer light emitting layer 140 and an inner light emitting layer 142. There is a gap between the outer light emitting layer 140 and the inner light emitting layer 142 and the gap is in a form of a hollow part 144. The light cover 14 is disposed on the concave part 103 of the tube-shaped heat dissipation base 10 correspondingly. A second fix member 143 is set on each of two sides of the light cover 14 and is corresponding to and assembled with the first fix member 107 of the tube-shaped heat dissipation base 10. Thus the light cover 14 is fixed on the concave part 103 of the tube-shaped heat dissipation base 10 correspondingly. In this embodiment of the present invention, the first fix member 107 is slide rail 107 and the second fix member 143 is a slide slot. Thus the second fix member 143 is assembled with the first fix member 107 slidingly. Thereby when the second fix member 143 of the light cover 14 is assembled and fixed with the first fix member 107 of the tube-shaped heat dissipation base 10, the inner light emitting layer 142 of the light cover 14 presses on the printed circuit board 12 in order to fix the printed circuit board 12 onto the concave part 103 of the tube-shaped heat dissipation base 10. There is no need to use any other fix member such as screws, rivets or others for fixing.

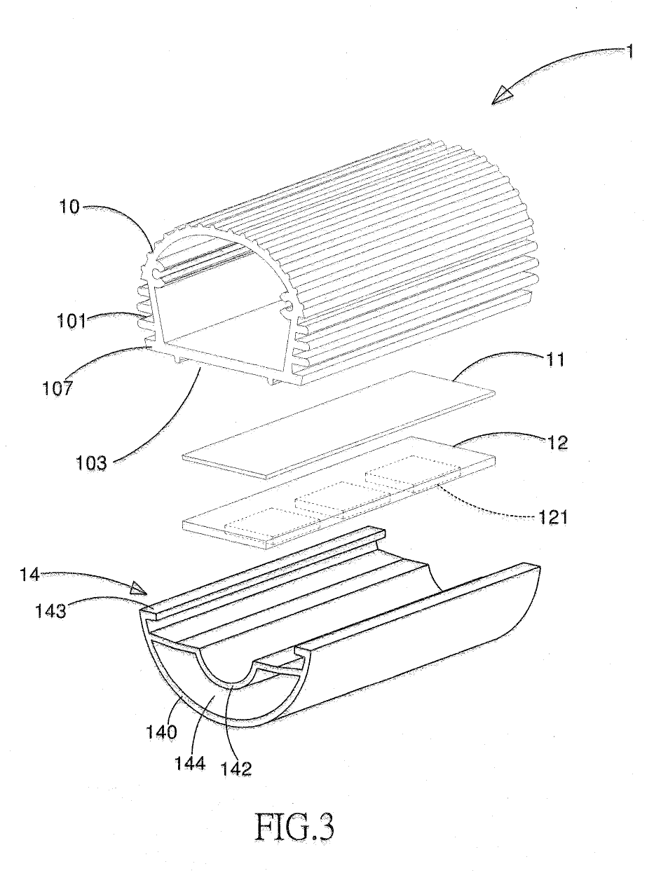

Refer to FIG. 3, an explosive view of another embodiment is revealed. As shown in figure, in order to increase heat dissipation effect of LED light tube 1 further includes a heat dissipation layer 11 disposed in the concave part 10 of the tube-shaped heat dissipation base 10. As to the printed circuit board 12, it is fixed on the heat dissipation layer 11. By the heat dissipation layer 11, heat energy generated by the light emitting diodes 121 on the printed circuit board 12 is transferred effectively. In this embodiment, the heat dissipation layer 11 can be a thermal pad or other thermal coatings used as medium. By means of the thermal pad or thermal coating, heat energy is conducted from the printed circuit board 12 to the concave part 103 of the tube-shaped heat dissipation base 10 effectively so as to achieve good heat dissipation.

Moreover, although each LED 121 is a point light source, light emitted from the outer light emitting layer 140 and the inner light emitting layer 142 of the light cover 14 and projected to a surface of an object still forms a plurality of light points when the light from each LED 121 is not even. Thus in order to make light emitted from each LED 121 become more even or increase luminance of the light from the LED 121, the LED light of the present invention is added with at least one optical element. The optical element can be a diffuser and/or a brightness enhancement film. The diffuser makes light from the LED 121 becomes even so that light through the light cover 14 doesn't form a plurality of light points. The brightness enhancement film further reflects light from the LED 121 so as to increase luminance of the light from the plurality of LED 121. Furthermore, in order to increase diversity of light patterns, the optical element can be a fluorescent plate having ability to change wavelength of the light from the LED 121 and generate light with different colors. Thus the efficiency of the LED light tube 1 is enhanced effectively. The following embodiments illustrate the addition of optical elements to the present invention.

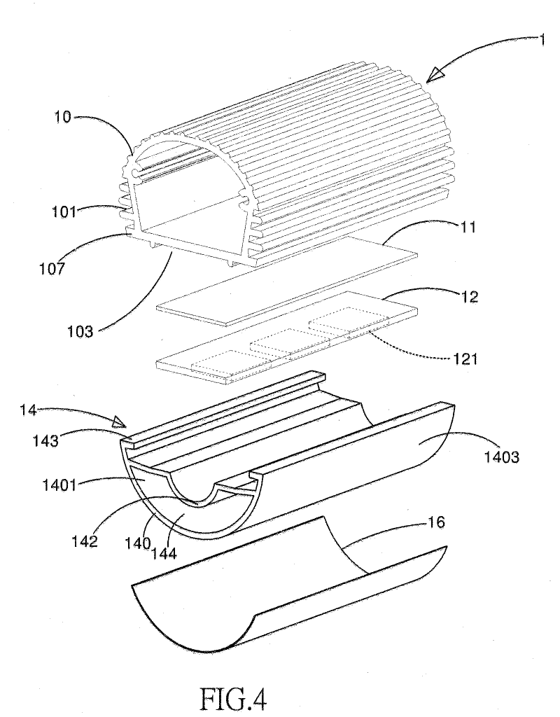

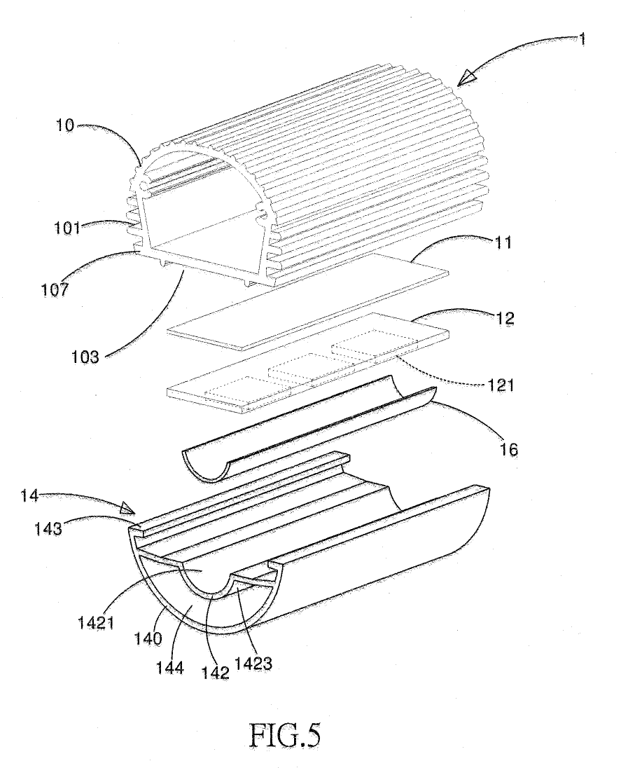

Refer to FIG. 4, an explosive view of a further embodiment is disclosed. An optical element 16 is disposed on the outer light emitting layer 140 of the light cover 14 that consists of an inner surface 1401 and an outer surface 1403. In this embodiment, the optical element 16 is arranged at the outer surface 1403 of the outer light emitting layer 140 of the light cover 14. Yet the optical element 16 can also be arranged at the inner surface 1401 of the outer light emitting layer 140 of the light cover 14. Also refer to FIG. 5, the optical element 16 is disposed on the outer light emitting layer 140 of the light cover 14 in the above embodiment but in the present embodiment, the optical element 16 is disposed on the inner light emitting layer 142 of the light cover 14. The inner light emitting layer 142 of the light cover 14 includes an outer surface 1421 and an inner surface 1423. In this embodiment, the optical element 16 is set on, but not limited to, the outer surface 1421 of the inner light emitting layer 142 of the light cover 14. The optical element 16 can also be disposed on the inner surface 1423 of the inner light emitting layer 142 of the light cover 14. Moreover, the optical element 16 can also be arranged at the outer light emitting layer 140 and at the inner light emitting layer 142 simultaneously. Furthermore, the optical element 16 can also be set on the hollow part 144 between the outer light emitting layer 140 and the inner light emitting layer 142. For example, various fluorescent plates are mounted in the hollow part 144 to generate light with different colors for increasing efficiency of the LED light tube 1 significantly.

Besides disposition of the optical element 16 for evenness of the light emitted from the LED 121, wavelength conversion of the light emitted from the LED 121 and increased luminance of the light emitted from the LED 121, a plurality of optical particles is added into the light cover 14 and this also makes the light emitted from the LED 121 become even, convert wavelength of the light emitted from the LED 121 and increase luminance of the light emitted from the LED 121 after the light emitted from the LED 121 passing the light cover 14 with these optical particles. This is due to that the optical particles include a plurality of diffusion particles, a plurality of fluorescent particles and/or a plurality of brightness enhancement particles. The diffusion particles homogenize the light emitted from the LED 121 and the fluorescent particles converts wavelength of the light from the LED 121 while the brightness enhancement particles reflect the light from the LED 121 so as to improve luminance of the light emitted from the LED 121.

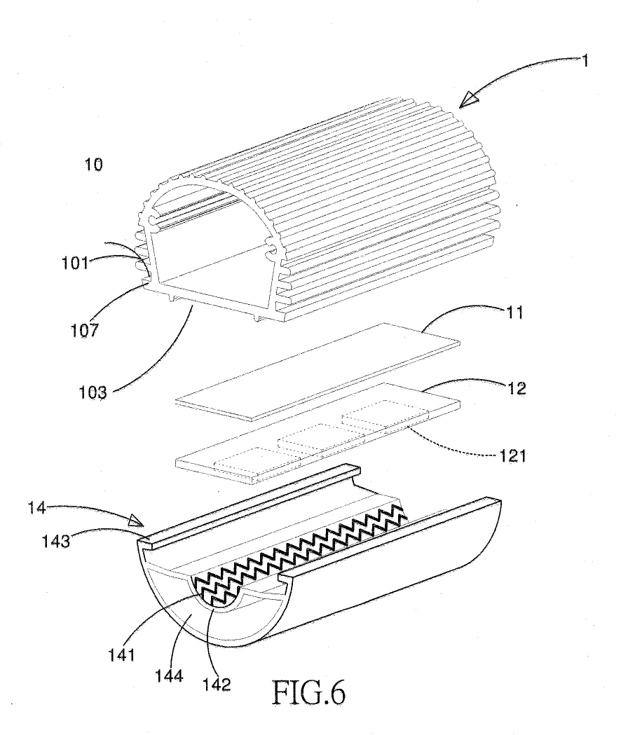

Refer to FIG. 6, a further embodiment is disclosed. As shown in figure, in order to increase radiation directions of the output light emitted from the LED 121, an optical pattern 141 is engraved on a surface of the outer light emitting layer 140 or the inner light emitting layer 142 of the light cover 14. In this embodiment, an optical pattern 141 is engraved on the surface of the inner light emitting layer 142 of the light cover 14 so as to increase roughness of the surface of the inner light emitting layer 142 of the light cover 14. This leads to a direction change of the light emitted from the LED 121 and further increase radiation directions of the output light emitted from the LED 121. Similarly, the optical pattern 141 can also be engraved on a surface of the outer light emitting layer 140.

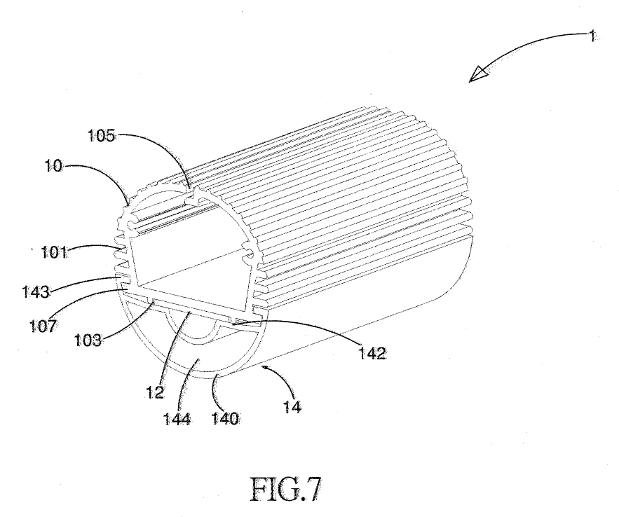

Refer to FIG. 7, a perspective view of a further embodiment is revealed. The embodiment in FIG. 1 reveals the tube-shaped heat dissipation base 10 disposed with a plurality of heat dissipation fins 101 so as to transfer heat generated by the LED light tube 1. In this embodiment, in order to increase heat dissipation effect of the LED light tube 1, at least one heat dissipation slot 105 is arranged at an outer surface of the tube-shaped heat dissipation base 10. The heat dissipation slot 105 is set along the longitudinal direction of the tube-shaped heat dissipation base 10 and is connected with an inner space thereof. Thereby, the heat dissipation slot 105 allows air currents inside and outside the tube-shaped heat dissipation base 10 connecting with each other and enhances convective air currents for accelerating exhaust of hot air inside the tube-shaped heat dissipation base 10. The heat dissipation effect of the LED light tube 1 is further improved. Moreover, a cross section of an embodiment of the heat dissipation slot 105 is L-shaped. Such design can prevent an inner structure of the tube-shaped heat dissipation base 10 from showing. Thus the appearance is maintained and external dust is prevented from entering into the tube-shaped heat dissipation base 10.

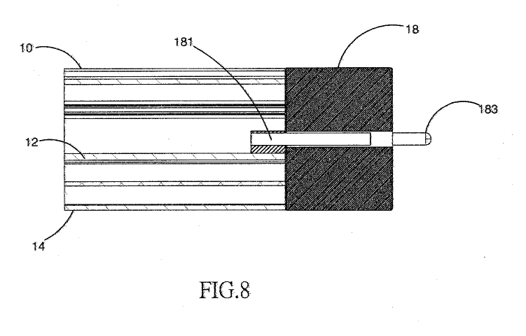

Refer to FIG. 8, a schematic drawing showing a cross section of a further embodiment of the present invention is disclosed. A LED light tube 1 of this embodiment further includes two joints 18 respectively disposed on two ends of the tube-shaped heat dissipation base 10 as well as the light cover 14. In the figure, only the joint 18 connected with one end of the tube-shaped heat dissipation base 10 and the light cover 14 is shown. The joint 18 of this embodiment is a rotary joint whose one end includes a rotating shaft 181 and the other end includes two pins 183. The rotating shaft 181 is fixed on the tube-shaped heat dissipation base 10. While rotating the joint 18, the angle of two pins 183 is adjusted so as to ensure correct lighting direction when the LED light tube 1 is assembled with a light holder.

In summary, a LED light of the present invention includes a tube-shaped heat dissipation base disposed with a plurality of heat dissipation fins for improving heat dissipation effect of the LED light and further increasing lighting emitting efficiency of the LED light. Moreover, when the light cover is fixed on the tube-shaped heat dissipation base, a light emitting layer in the light cover directly presses a printed circuit board against the tube-shaped heat dissipation base so as to fix the printed circuit board on the tube-shaped heat dissipation base. Thus there is no need to use any other components for fixing the printed circuit boards. Furthermore, the present invention is disposed with optical elements or the light cover is added with a plurality of optical particles so as to homogenize the light from the LED, convert wavelength of the light from the LED, or even increase luminance of the light from the LED. In addition, an optical pattern is engraved on a surface of the light cover for increasing radiation directions of output light from the LED. In order to further improve heat dissipation effect of the LED light, a heat dissipation slot is disposed on the tube-shaped heat dissipation base with the plurality of heat dissipation fins for enhancing convection of air currents inside and outside the tube-shaped heat dissipation base and further improving heat dissipation effect of the LED light. The LED light is further arranged with two rotary joints on two ends of the tube-shaped heat dissipation base as well as the light cover. The rotary joint is rotated for changing the angle of two pins of the joint so as to ensure correct lighting direction of the LED light assembled with a light holder.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A light emitting diode (LED) light tube comprising:
a tube-shaped heat dissipation base disposed with a first fix member on each of two sides thereof and arranged with a plurality of heat dissipation fins;
a printed circuit board arranged at the tube-shaped heat dissipation base and having a plurality of light emitting diode; and
a light cover disposed on the tube-shaped heat dissipation base correspondingly and having an inner light emitting layer, an outer light emitting layer, a hollow part formed by a gap between the inner light emitting layer and the outer light emitting layer and a second fix member disposed on each of two sides thereof;
wherein the second fix member corresponds to and assembles with the first fix member firmly while the inner light emitting layer presses on the printed circuit board in order to fix the printed circuit board on the tube-shaped heat dissipation base.

2. The LED light tube as claimed in claim 1, wherein the tube-shaped heat dissipation base is disposed with a concave part in which the printed circuit board is mounted thereof.

3. The LED light tube as claimed in claim 2, further includes a heat dissipation layer arranged at the concave part of the tube-shaped heat dissipation base and the printed circuit board is fixed on the heat dissipation layer.

4. The LED light tube as claimed in claim 1, further includes at least one optical element disposed on an inner surface and/or an outer surface of the outer light emitting layer of the light cover.

5. The LED light tube as claimed in claim 1, further includes at least one optical element disposed on an inner surface and/or an outer surface of the inner light emitting layer of the light cover.

6. The LED light tube as claimed in claim 1, wherein the LED light further includes at least one optical element disposed on the hollow part.

7. The LED light tube as claimed in claim 4, wherein the optical element is a diffuser, a fluorescent plate and/or a brightness enhancement film.

8. The LED light tube as claimed in claim 5, wherein the optical element is a diffuser, a fluorescent plate and/or a brightness enhancement film.

9. The LED light tube as claimed in claim 6, wherein the optical element is a diffuser, a fluorescent plate and/or a brightness enhancement film.

10. The LED light tube as claimed in claim 1, wherein the light cover includes a plurality of optical particles.

11. The LED light tube as claimed in claim 10, wherein the optical particles are a plurality of diffusion particles, a plurality of fluorescent particles and/or a plurality of brightness enhancement particles.

12. The LED light tube as claimed in claim 1, wherein an optical pattern is engraved on a surface of the inner light emitting layer or the outer light emitting layer of the light cover.

13. The LED light tube as claimed in claim 1, wherein the tube-shaped heat dissipation base includes at least one heat dissipation slot that is disposed along a longitudinal direction of the tube-shaped heat dissipation base and is connected with an inner space of the tube-shaped heat dissipation base.

14. The LED light tube as claimed in claim 13, wherein a cross section of the heat dissipation slot is L-shaped.

15. The LED light tube as claimed in claim 1, further includes two joints respectively arranged at two ends of the tube-shaped heat dissipation base and the light cover.

16. The LED light tube as claimed in claim 15, wherein the joint is a rotary joint with two pins and the joint is rotated so as to adjust an angle of the two pins.

17. The LED light tube as claimed in claim 16, wherein the joint includes a rotating shaft that is fixed on the tube-shaped heat dissipation base for rotating the joint and adjusting an angle of the two pins.
